(19) United States
(12) Patent Application Publication
(10) Pub. No.: US 2021/0285460 A1
(43) Pub. Date: Sep. 16, 2021

(54) METHOD FOR CONTROLLING FLOW SEPARATION ON SUCTION SURFACE OF STATOR BLADE OF AXIAL COMPRESSOR/FAN BY MEANS OF MICRO AIR INJECTION

(71) Applicant: Nanjing University of Aeronautics and Astronautics, Nanjing City (CN)

(72) Inventors: Zhenggui Zhou, Nanjing City (CN); Huan Zheng, Nanjing City (CN); Xinlong Ye, Nanjing City (CN)

(21) Appl. No.: 17/197,538

(22) Filed: Mar. 10, 2021

(30) Foreign Application Priority Data
Mar. 10, 2020 (CN) 202010160489.4

(51) Int. Cl. F04D 29/38; F04D 27/00; F01D 5/18; F01D 9/02

(52) U.S. Cl. CPC F04D 29/384; F04D 27/005; F05D 2240/12; F01D 9/02; F01D 5/18

(57) ABSTRACT

A method for controlling flow separation on a suction surface of a stator blade of an axial compressor/fan by means of micro air injection is characterized in that a stator blade of the axial compressor/fan is hollow and is formed by several two-dimensional hollow blade profiles stacked spanwisely; the blade profile is slotted to form a slotted blade profile; an inlet of a slot is at leading edge of the blade profile and an outlet is on a suction surface; when an airflow flows through a blade, a small portion of the airflow flows into the slot and then is ejected via the outlet; and the inlet of the slot exactly faces the incoming flow. The method can be used for an axial compressor or an axial fan to reduce flow loss and improve its efficiency.

### CROSS REFERENCE TO RELATED APPLICATIONS

This application claims priority, and benefit under 35 U.S.C. § 119(e) of Chinese Patent Application No. 202010160489.4 filed Mar. 10, 2020. The disclosure of the prior application is hereby incorporated by reference as if fully set forth below.

### TECHNICAL FIELD

The present disclosure relates to the technical field of aerodynamics, in particular to a method for controlling flow separation on a suction surface of a stator blade of an axial compressor/fan by means of micro air injection generated by velocity impulse.

### BACKGROUND

Stators and rotors are cooperated to form stages of an axial compressors/fan. The stators are used to change flow directions and decelerate and pressurize the flow. With an increase in the stage pressure ratio of the axial compressors/fans, the inlet velocity and the flow turning angle of the stators increase. In this case, the thickness of the boundary layers on suction surfaces increases, and even flow separation occurs. As a result, flow loss increases. To increase the thrust-to-weight ratio of aero-engines, the compressors/fans have always been developed in the direction of high stage pressure ratios. Therefore, for aviation compressors/fans, it is more valuable to control boundary layers on the suction surfaces of the stators.

In November 2019, the paper “influence of slotting in blade root on performance of conventionally loaded high-velocity compressor cascade” was published by Tang Yumeng et al in the Journal of Engineering Thermophysics. In this paper, compressor blades were slotted in middle span to form jet flows of high-momentum for blowoff of boundary layers on suction surfaces, and different solutions were compared by means of numerical simulation to show the effectiveness of slotting on controlling the flow separation. Since the flow energy difference between the pressure surface and the suction surface is small, the jet formed by the slotting has weaker control over the boundary layers on the suction surfaces.

### SUMMARY

To overcome the shortcomings of the prior art, the present disclosure provides a method for controlling flow separation on a suction surface of a stator blade of an axial compressor/fan by means of micro air injection generated by velocity impulse. This can suppress the boundary layer on the suction surface of the stator blade of the axial compressor/fan, thus reducing flow loss of the stator and improving efficiency of the axial compressor/fan.

In order to achieve the above objective, the present disclosure adopts the following technical solution:

A method for controlling flow separation on a suction surface of a stator blade of an axial compressor/fan by means of micro air injection is provided, where a blade profile is slotted to form a slotted blade profile, a slot has one end (inlet) at a leading edge of the blade profile and the other end (outlet) on a suction surface of the blade profile; and when an airflow flows through a blade, a small portion of the airflow flows into the slot and then is ejected via the outlet.

Further, the inlet of the slot in the blade profile may exactly face an incoming flow.

Further, the outlet is located on the suction surface where the boundary layer needs to be blown off.

Further, the shape of the slot in the blade profile may be optimized as follows: the shape of the slot in the blade profile is initially determined artificially; the flow field of the cascade formed by the slotted blade profiles is calculated by means of numerical simulation; then the shape is modified according to analysis on the structure of the flow field; and finally, an optimized shape is obtained.

Beneficial effects: compared with the prior art, the method for controlling flow separation on a suction surface of a stator blade of an axial compressor/fan by means of micro air injection has the following advantages: higher momentum micro air injection can be achieved to effectively blow off the boundary layer on the suction surface of the blade, thus reducing flow loss and improving efficiency of the axial compressor/fan.

### BRIEF DESCRIPTION OF THE DRAWINGS

FIG. 1 is a slotted blade profile of a stator;

FIG. 2 is a partial enlarged view of a front portion of the slotted blade profile;

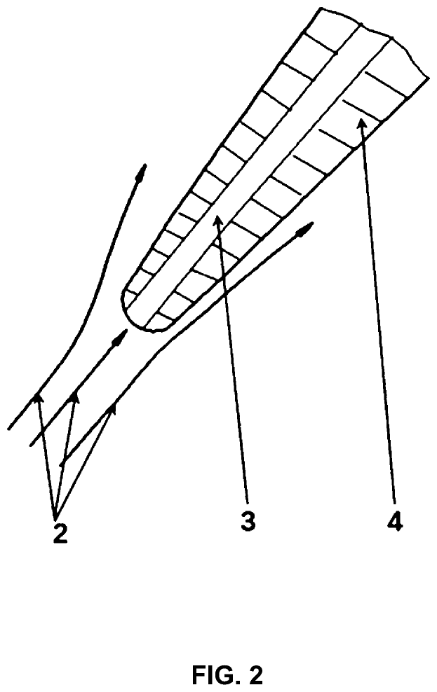

FIG. 3 shows a slotted blade profile in the embodiment;

FIGS. 4A and 4B show flow lines and contours of Mach numbers of flow fields of two cascades formed by a slotted blade profile and an unslotted blade profile in the embodiment; and

FIG. 5 is the flow loss and flow turning angle with attack angle of the two cascades in the embodiment.

In the figures, 1. leading edge of a blade profile, 2. a small portion of airflow, 3. slot in the blade profile, 4. blade profile, 5. suction surface of the blade profile, 6. pressure surface of the blade profile, 7. chord of the blade profile, 8. rear edge of the blade profile.

### DETAILED DESCRIPTION

The present disclosure is further described below with reference to the accompanying figures and embodiments.

Implementation

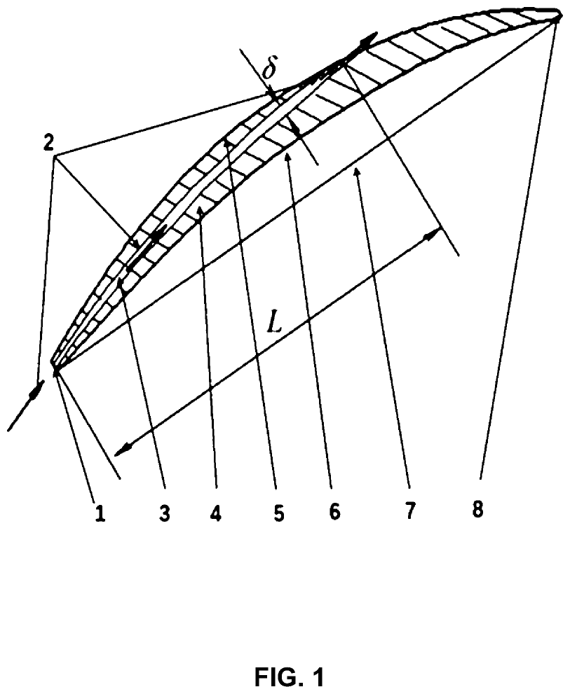

A method of the present disclosure for controlling a boundary layer on a suction surface of a stator of an axial compressor/fan (i.e., a fan of a compressor) by means of micro air injection generated by velocity impulse is described below with reference to FIG. 1.

Generally, a number of blade profiles are stacked in the radial direction according to a certain stacking rule, and the profiles are used as the skeleton and spline curved surfaces are used to cover the skeleton to form an axial compressor/fan stator blade. Therefore, the blade profiles are basic elements of the blade, and aerodynamic performance of the blade is determined by the blade profiles. The stator blade in the present disclosure is hollow and is formed by slotted blade profiles. A slot (3) in each blade profile (4) has one end (inlet) at a leading edge (1) of the blade profile and the other end (outlet) at a position where a boundary layer on the suction surface (5) of the blade profile is required to be blown off. When airflows flow through the blade, a small portion of the airflows (2) flow into the slot (3) and then are ejected via the outlet. The jet flow increases momentum on the boundary layer at this position, suppresses growth of the boundary layer, and controls flow separation on the boundary layer. In this way, flow loss of the stator is reduced, and efficiency of the axial compressor/fan is improved. Because an inlet of the slot exactly faces incoming flows, the small portion of the airflows in the slot has high momentum, so that a jet flow from the outlet of the slot has a high velocity. Based on this, the boundary layer on the suction surface can be effectively suppressed.

The blade profile mainly has the following aerodynamic performance indexes: under a certain inlet Mach number and inlet angle, a given airflow turning angle is reached and the flow loss is as small as possible, and attack angle range of the low loss is as large as possible. the shape of the slot is initially determined artificially; the flow field of the cascade formed by the slotted blade profiles is calculated by means of numerical simulation; the shape of the slot in the blade profile is modified according to analysis on structure of the flow field. For example, a width δ of the slot is increased to increase the flow rate in the slot; a distance L between the outlet of the slot and the leading edge of the blade profile is reduced to control the boundary layer on the suction surface earlier. Finally, an optimized slot in the blade profile is obtained to achieve excellent aerodynamic performance of the blade profile and low flow loss in the slot.

### Embodiment

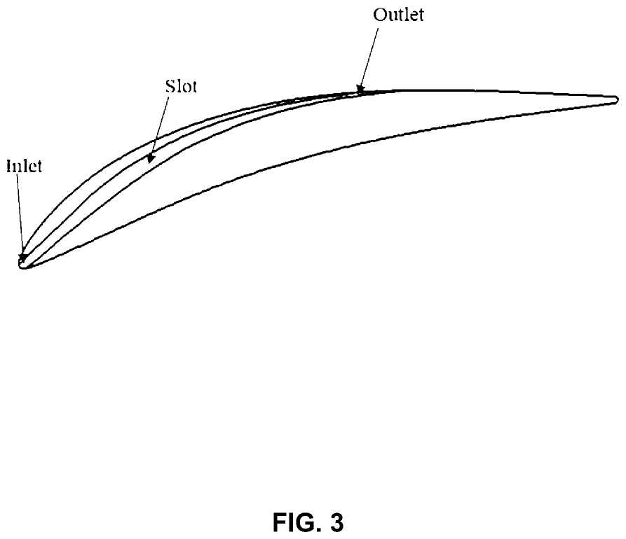

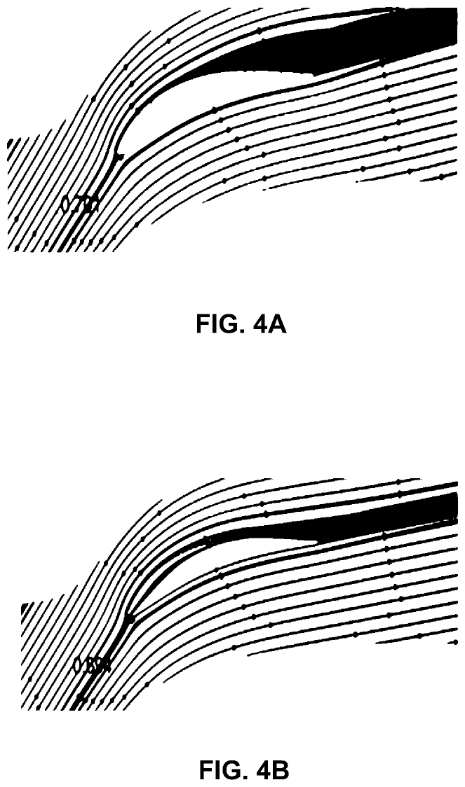

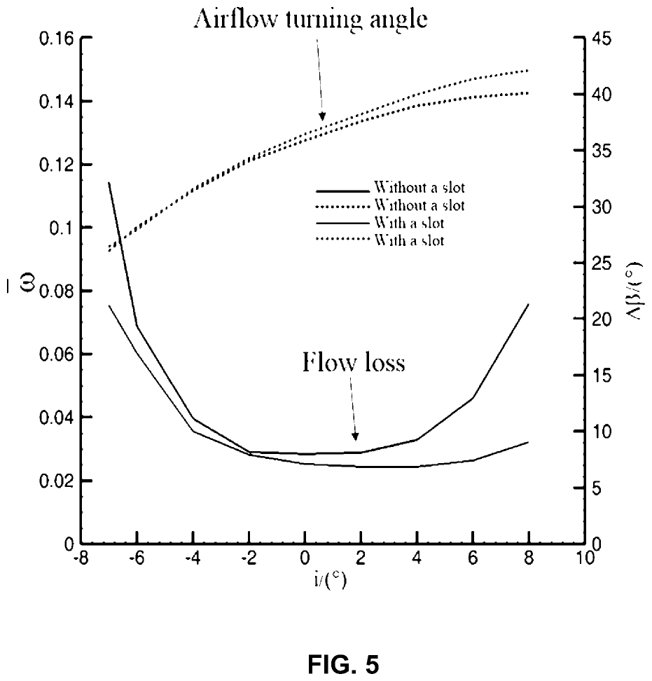

FIG. 3 shows a blade profile of a stator of an axial compressor, slotted to achieve micro air injection on the suction surface. Table 1 shows main performance parameters of the cascade. The width of the inlet of the slot in the blade profile accounts for 1% of the chord length, and the width of the outlet of the slot in the blade profile accounts for 0.5% of the chord length. FIGS. 4A and 4B show comparison of the simulated flow fields of the two cascades formed by the slotted blade profiles (FIG. 4B) and unslotted blade profiles (FIG. 4A) at a large positive attack angle. As shown in FIGS. 4A and 4B, flow separation on a suction surface of the slotted blade profile can be suppressed effectively. FIG. 5 shows comparison of flow loss ω̅ and flow turning angles Δβ of the two cascades. As shown in FIG. 5, at a positive attack angle, the slotting can significantly reduce the flow loss and increase the flow turning angle. The greater the attack angle, the greater the degree of improvement. The technical solution of this application can effectively inhibit the flow separation of the suction surface and reduce the flow loss. Therefore, this patent can be widely used in engineering practice.

TABLE 1
Main parameters of the cascade

| Inlet Mach | Cascade | | Flow | |
|---|---|---|---|---|
| number | Density | Inlet angle (°) | turning angle (°) | Loading factor |
| 0.7 | 1.5 | 42 | 36 | 0.45 |

The above descriptions are merely preferred implementations of the present disclosure. It should be noted that a person of ordinary skill in the art may further make several improvements and modifications without departing from the principle of the present disclosure, and such improvements and modifications shall also be deemed as falling within the protection scope of the present disclosure.

What is claimed is:

1. A method for controlling flow separation on a suction surface of a stator blade of an axial compressor/fan by means of micro air injection, wherein the stator blade of the axial compressor/fan is hollow and is formed by a plurality of two-dimensional hollow blade profiles stacked spanwisely; a blade profile is slotted to form a slotted blade profile; an inlet of a slot is at a leading edge of the blade profile and an outlet is on the suction surface; when an airflow flows through a blade, a portion of the airflow flows into the slot and then is ejected via the outlet; and the inlet of the slot exactly faces an incoming flow.

2. The method according to claim 1, wherein the outlet of the slot, located on the suction surface of the blade profile, is located on the suction surface where a boundary layer needs to be blown off.

3. The method according to claim 1, wherein a shape of the slot in the blade profile is initially determined artificially; a flow field of a cascade formed by slotted blade profiles is calculated by numerical simulation; the shape of the slot in the blade profile is modified according to analysis on structure of the flow field, wherein a width δ of the slot is increased to increase a flow rate in the slot, a distance L between the outlet of the slot and the leading edge of the blade profile is reduced to control a boundary layer on the suction surface earlier; and finally, an optimized slot in the blade profile is obtained to achieve an aerodynamic performance of the blade profile and low flow loss in the slot.

4. The method according to claim 1, wherein the method is used for controlling flow separation on a suction surface of a rotor blade of the axial compressor/fan.

5. The method according to claim 2, wherein the method is used for controlling flow separation on a suction surface of a rotor blade of the axial compressor/fan.

6. The method according to claim 3, wherein the method is used for controlling flow separation on a suction surface of a rotor blade of the axial compressor/fan.
